(19) United States
(12) Patent Application Publication
(10) Pub. No.: US 2021/0328514 A1
(43) Pub. Date: Oct. 21, 2021

(54) DUAL DC-DC CONVERTER

(71) Applicant: MAGNA INTERNATIONAL INC., Aurora (CA)

(72) Inventor: Daniel SCHLEICHER, St. Valentin (AT)

(21) Appl. No.: 17/272,551

(22) PCT Filed: Sep. 5, 2019
(86) PCT No.: PCT/CA2019/051242

§ 371 Date: Mar. 1, 2021

Related U.S. Application Data
(60) Provisional application No. 62/728,300, filed on Sep. 7, 2018.

(51) Int. Cl. H02M 3/158; H02J 7/00; H02M 1/00

(52) U.S. Cl. CPC H02M 3/1586; H02J 2207/20; H02M 1/008; H02J 7/0024

(57) ABSTRACT

A dual DC-DC converter includes a controller signaling a plurality of switch sets for charging a first battery connected to a first DC output and a second battery connected to a second DC output. Each of the switch sets includes a high-side switch configured to switch a DC electrical input to a common node and a low-side switch configured to switch a ground to the common node. A filter capacitor is connected between each of the DC outputs and a ground. A mode switch is connected between the DC outputs and is opened to allow the dual DC-DC converter to be operated with each of the DC outputs having different voltages for independently charging the batteries at different states of charge. The mode switch is closed when the voltages on each of the DC outputs are equal or within a predetermined threshold.

### CROSS-REFERENCE TO RELATED APPLICATION

This PCT International Patent Application claims the benefit of and priority to U.S. Provisional Patent Application Ser. No. 62/728,300 filed on Sep. 7, 2018, titled “Dual DC-DC Converter,” the entire disclosure of which is hereby incorporated by reference.

### FIELD

The present disclosure relates generally to DC-DC converters, and more specifically to DC-DC converters for battery charging.

### BACKGROUND

In some applications, such as in some Electric Vehicles (EVs), it is advantageous to have two or more low voltage (LV) batteries. Those batteries can be used to supply two or more low voltage circuits. It is advantageous to charge those batteries from a single charger, such as a DC-DC converter, by connecting them together. For example, the batteries may be connected in a series or parallel configuration, or in a more complex combination thereof. If the charge level of the batteries are not equal, very high balancing currents will flow from the higher charged battery to the more depleted one when the batteries are connected. These high currents can reduce the usable lifetime and/or can cause damage to the batteries.

A low voltage balancer (LVB) may be used to balance electrical currents between two or more batteries and to prevent the problem with very high balancing currents. Such LVB devices are commonly used in recreational vehicles. However, LVB devices are generally expensive and add additional cost, complexity, and weight to a vehicle.

### SUMMARY

A dual DC-DC converter includes a first switch set having a first high-side switch. The first switch set is configured to generate a first DC output voltage upon a first output node by selectively closing the first high-side switch to couple an input node having a DC input voltage to a first common node. The dual DC-DC converter also includes a second switch set having a second high-side switch. The second switch set is configured to generate a second DC output voltage upon a second output node by selectively closing the second high-side switch to couple the input node to a second common node. The dual DC-DC converter also includes a mode switch that is configured to selectively couple the first output node to the second output node.

A battery charger includes a first switch set configured to control a first DC output voltage on a first output node and to control a rate of charge into a first battery connected thereto. The battery charger also comprises a second switch set configured to control a second DC output voltage on a second output node and to control a rate of charge into a second battery connected thereto. The battery charger also includes a mode switch that is electrically connected between the output nodes and which is operable in a non-conductive mode to provide electrical isolation between the output nodes for allowing the batteries to be charged independently. The mode switch is also operable in a conductive mode to provide electrical continuity between the output nodes.

A method of operating a dual DC-DC converter is also provided. The method includes: generating a first DC output voltage upon a first output node by switching a DC input voltage; generating a second DC output voltage upon a second output node by switching the DC input voltage; and coupling the first output node to the second output node with a mode control switch to cause the second output voltage to be equal to the first output voltage with the mode control switch in a closed condition.

### BRIEF DESCRIPTION OF THE DRAWINGS

Further details, features and advantages of designs of the invention result from the following description of embodiment examples in reference to the associated drawings.

FIG. 1 is a schematic diagram of a DC-DC converter of the prior art;

FIG. 2 is a schematic diagram of a dual DC-DC converter in of the present disclosure; and

FIG. 3 is a schematic diagram of another dual DC-DC converter of the present disclosure; and

FIG. 4 is a flow chart showing steps in a method of operating a dual DC-DC converter.

### DETAILED DESCRIPTION

Recurring features are marked with identical reference numerals in the figures, in which example embodiments of a dual DC-DC converter are disclosed.

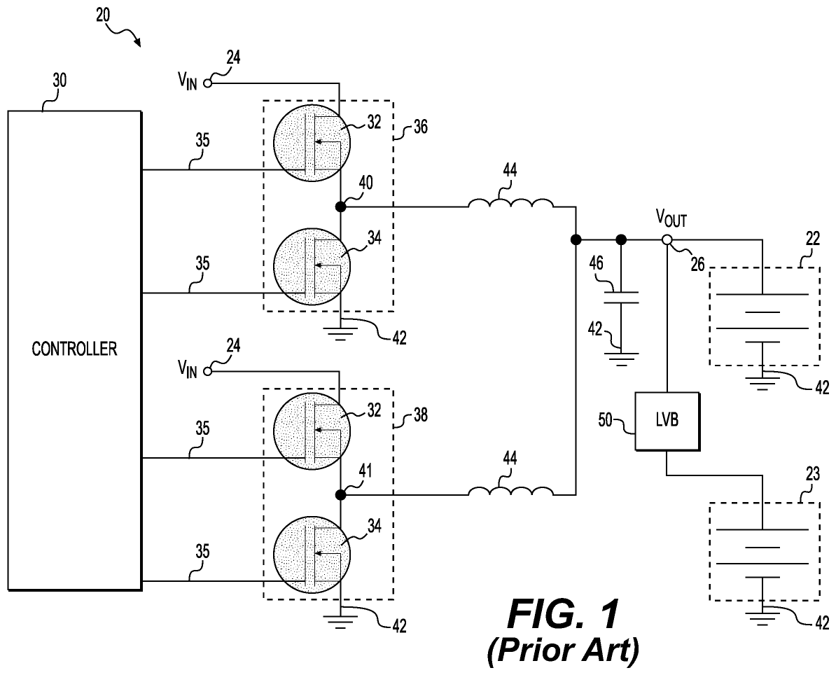

FIG. 1 illustrates an example of a conventional DC-DC converter 20 for charging a plurality of batteries 22, 23. The DC-DC converter 20 takes electrical current on an input node 24 having a DC input voltage V_{IN}, which may be, for example, a high voltage such as 400 to 600 VDC and generates a DC output voltage V_{OUT} on an output node 26. The batteries 22, 23 are shown connected to the output node 26 in a parallel configuration. However, the batteries 22, 23 may also be connected to the output node 26 in series or in a more complex configuration, such as a hybrid series/parallel circuit. A low voltage balancer (LVB) 43 is connected between the output node 26 and the second battery 23 for regulating current being supplied to or from the second battery 23, which may occur, for example, where the batteries 22, 23 are unbalanced with different states of charge. The output node 26 may be energized to a predetermined voltage for charging one or more batteries. The DC output voltage V_{OUT} may be a low voltage such as, for example, 3 to 14 VDC. The DC output voltage V_{OUT} may depend on the particular type and configuration of the batteries 22, 23 connected to the output node 26.

The DC-DC converter 20 includes a controller 30 signaling a plurality of switches 32, 34 arranged in switch sets 36, 38 to control the DC output voltage V_{OUT} on the output node 26 to its predetermined voltage. A first switch set 36 includes a high-side switch 32 configured to switch the input node 24 to a first common node 40 and a low-side switch 34 configured to switch the first common node 40 to a ground 42. A second switch set 38 includes a high-side switch 32 configured to switch the input node 24 to a second common node 41 and a low-side switch 34 configured to switch the second common node 41 to the ground 42. The second switch set 38 may be similar in construction and in operation to the first switch set 36. An inductor 44 is connected between each of the common nodes 40, 41 and the output node 26 to limit the current slew rate through the switches 32, 34. In other words, the inductors 44 prevent a large voltage spike that may otherwise be induced when the switches 32, 34 are switched between conducting and non-conducting modes and vice versa. A filter capacitor 46 is connected between the output node 26 and the ground 42 to reduce ripple on in the DC output voltage V_{OUT}.

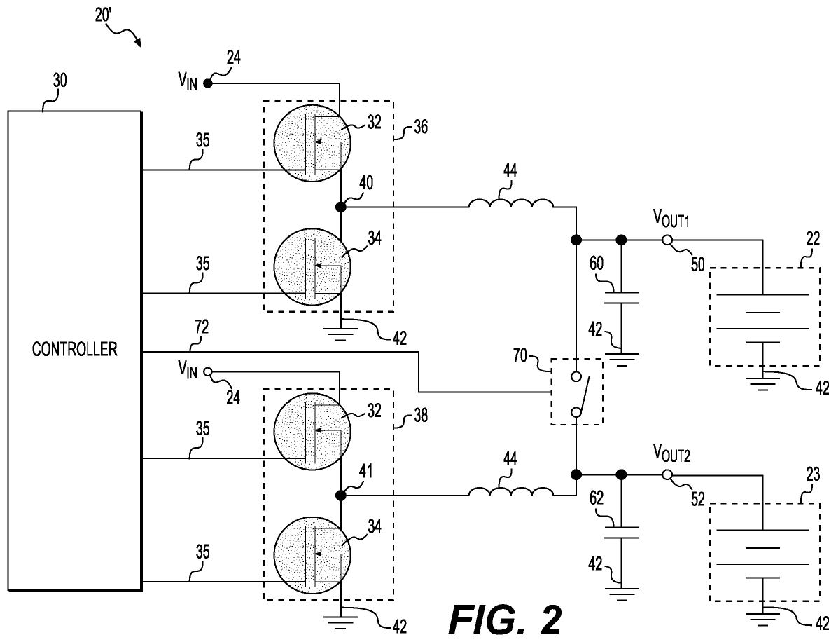

The controller 30 may employ known methods, such as pulse width modulation (PWM) to control the switches 32, 34. The switches 32, 34 may be metal oxide semiconductor field effect transistor (MOSFET) type devices, such as those indicated on FIGS. 1-2, although other types of devices may be used such as, for example, other types of field effect transistors (FETs), triacs, or junction transistors. In some embodiments, one or more of the switches 32, 34 may be insulated gate bipolar transistors (IGBTs) or Gallium Nitride (GaN) transistors.

FIG. 2 illustrates a dual DC-DC converter 20′ according to aspects of the present disclosure. Specifically, FIG. 2 illustrates the dual DC-DC converter 20′ configured as a battery charger for charging a plurality of batteries 22, 23. However, it should be appreciated that the dual DC-DC converter 20′ may have different applications and/or configurations. For example, the dual DC-DC converter 20′ may be configured to supply DC power to one or more different loads in addition to or instead of battery charging. For example, the dual DC-DC converter 20′ may be configured to supply power to two non-battery loads, such as motors or resistive heaters. Additionally or alternatively, the dual DC-DC converter 20′ may be configured to supply power to one or more batteries and also to one or more non-battery loads.

The dual DC-DC converter 20′ shown in FIG. 2 is similar in construction to the example conventional DC-DC converter 20, as described above. However, instead of a single, common, output node 26, the dual DC-DC converter 20′ includes a first output node 50 having a first DC output voltage V_{OUT1} and a second output node 52 having a second DC output voltage V_{OUT2}, which may be different than the first DC output voltage V_{OUT1}. A first smoothing capacitor 60 is connected between the first output node 50 and the ground 42 to reduce ripple in the first DC output voltage V_{OUT1}. Similarly, a second smoothing capacitor 62 is connected between the second output node 52 and the ground 42 to reduce ripple in the second DC output voltage V_{OUT2}. A first battery 22 is connected to the first output node 50 and a second battery 23 is connected to the second output node 52. The switch sets 36, 38 may be operated in an interleaved mode or a multiphase mode. Additional switch sets 36, 38 allow for smaller sized smoothing capacitors 60, 62 due to lower current ripple, but can also increase costs. Therefore, a trade-off in the number of switch sets 36, 38 must be made in designing the DC-DC converter 20 for a given application.

A mode switch 70 is electrically connected between the output nodes 50, 52 and may be opened to allow the dual DC-DC converter 20′ to be operated with the each of the output nodes 50, 52 having different voltages. In this way, the batteries 22, 23 may be independently charged, particularly where they are unbalanced, for example, where the batteries 22, 23 have different states of charge. The mode switch 70 may be closed to provide electrical continuity between the output nodes 50, 52 when the DC output voltages V_{OUT1}, V_{OUT2} on each of those output nodes 50, 52 are equal to one another or are within a predetermined threshold.

With the mode switch 70 in a closed condition, the dual DC-DC converter 20′ may operate similarly to a conventional DC-DC converter 20, but with the two filter capacitors 46 connected together in parallel to provide a larger capacitance value than either of the two filter capacitors 46 operating independently. This larger capacitance allows the dual DC-DC converter 20′ to operate with lower ripple current. In other words, the dual DC-DC converter 20′ can provide its maximum charging power to both of the batteries 22, 23 at the same time with the mode switch 70 in the closed condition. The mode switch 70 may be controlled by the controller 30 or by another processor or circuit, such as a voltage comparator. In some embodiments, and as shown in FIG. 2, the controller 30 is configured to selectively assert a mode control line 72 to command the mode switch 70 to be the closed condition or the opened condition.

The dual DC-DC converter 20′ may include three or more output nodes 50, 52 and may include two or more mode switches 70 to provide selective isolation or connection therebetween. For example, a first mode switch 70 may provide selective isolation between the first output node 50 and the second output node 52, while a second mode switch (not shown) may provide selective isolation between the second output node 52 and a third output node (not shown). Furthermore, the dual DC-DC converter 20′ may include any number of switch sets 36, 38, provided that there is at least one switch set 36, 38 associated with each of the output nodes 50, 52.

In some embodiments, where the dual DC-DC converter 20′ is configured as a battery charger, the first switch set 36 is configured to control the first DC output voltage V_{OUT1} the first output node 50 and to control a rate of charge into the first battery 22 connected thereto. The second switch set 38 is configured to control the second DC output voltage V_{OUT2} on to second output node 52 and to thereby control a rate of charge into the second battery 23 connected thereto. The mode switch 70 is electrically connected between the output nodes 50, 52 and is operable in a non-conductive mode to provide electrical isolation between the output nodes 50, 52 for allowing the batteries 22, 23 to be charged independently. The mode switch 70 is also operable in a conductive mode to provide electrical continuity between the output nodes 50, 52. With the mode switch 70 in the conductive mode, the batteries 22, 23 may be charged or discharged together.

In some embodiments where the dual DC-DC converter 20′ is configured as a battery charger, the controller 30 is configured to assert the mode control line 72 to cause the mode switch 70 to be in the conductive mode in response to a difference between the first DC output voltage V_{OUT1} and the second DC output voltage V_{OUT2} being within a predetermined threshold. In other words, the first DC output voltage V_{OUT1} being within the predetermined threshold of the second DC output voltage V_{OUT2}, the batteries 22, 23 have a similar state of charge to one another, thus being able to be coupled together by the mode switch 70.

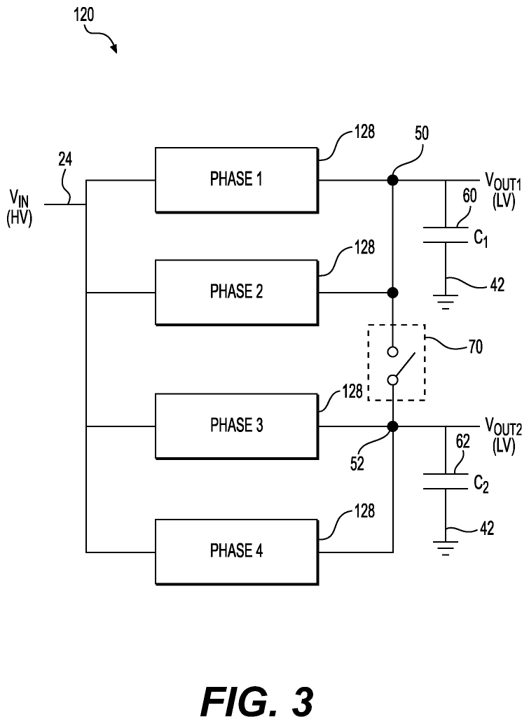

FIG. 3 is example schematic for another dual DC-DC converter 120 circuit in which four separate phase switches 128 each independently switch a common DC electrical input V_{IN} having a high voltage (HV), such as 400 to 600 VDC. The phase switches 128 may be operated in an interleaved mode or a multiphase mode. Each of the phase switches 128 may include one or more of the switches 32, 34. The first two of the phase switches 128, labeled “Phase 1” and “Phase 2” are each electrically connected to a first output node 50 which may operate at a low voltage (LV), such as 3 to 48 VDC. A first filter capacitor 60 is connected between the first output node 50 and a ground 42, and functions to reduce ripple in the first DC output voltage V_{OUT1} of the first output node 50 which can result from the operation of the phase switches 128.

The second two of the phase switches 128, labeled “Phase 3” and “Phase 4” are each electrically connected to a second output node 52, which may also operate at a low voltage (LV), such as 3 to 48 VDC. A second filter capacitor 45 is connected between the second output node 52 and a ground 42, and functions to reduce ripple in the second DC output voltage V_{OUT2} of the second output node 52 which can result from the operation of the phase switches 128. One or more of the phase switches 128 may also be configured to switch a ground 42 to one or more of the output nodes 50, 52.

A mode switch 70 is connected between the output nodes 50, 52, and may be operated in an opened, or non-conducting condition, thus providing for the output nodes 50, 52 to have DC output voltages V_{OUT1}, V_{OUT2} with different values. The mode switch 70 may be closed to provide electrical continuity between the output nodes 50, 52, thus causing the DC output voltages V_{OUT1}, V_{OUT2} to each have a same value. With the mode switch 70 in a closed condition, the output nodes 50, 52 may be able to provide a higher current and with a more consistent DC voltage by using more of the phase switches 128 and with a larger, combined filter capacitor 60, 62 than when compared with the output nodes 50, 52 operating independently, with the mode switch 70 in the opened condition.

Similarly to the dual DC-DC converter 20′ described above, the dual DC-DC converter 120 shown in FIG. 3 may include three or more output nodes 50, 52 and may include two or more mode switches 70 to provide selective isolation or connection therebetween. Furthermore, the dual DC-DC converter 120 may include any number of phase switches 128, provided that there is at least one phase switch 128 associated with each of the output nodes 50, 52.

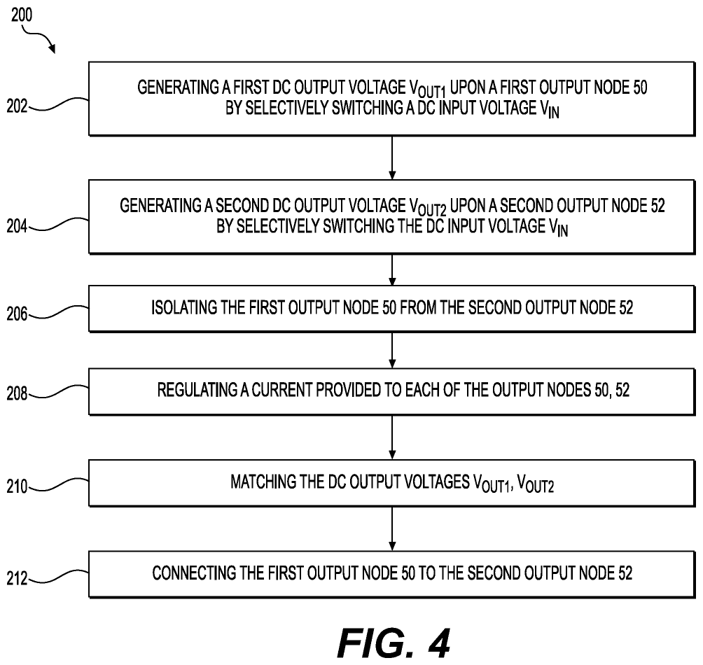

A method 200 of operating a dual DC-DC converter 20′ is shown in the flow chart of FIG. 4. In some embodiments, the dual DC-DC converter 20′ may be operated in accordance with the method 200 for charging two or more batteries 22, 23.

The method 200 includes generating a first DC output voltage V_{OUT1} upon a first output node 50 by selectively switching a DC input voltage V_{IN} at step 202. In some embodiments, such as in the example dual DC-DC converter 20′ shown in FIG. 2, step 202 is performed using one or more of the switches 32, 34 within the first switch set 36. More specifically, the controller 30 may command the one or more of the switches 32, 34 within the first switch set 36 using a control scheme, such as a pulse width modulation (PWM) scheme to generate the first DC output voltage V_{OUT1} by controlling an amount of time that of one or more of the switches 32, 34 within the first switch set 36 are energized within a given time period. In some embodiments, such as in the example dual DC-DC converter 20′ shown in FIG. 2, a first battery 22 is connected between the first output node 50 and a ground 42.

The method 200 also includes generating a second DC output voltage V_{OUT2} upon a second output node 52 by selectively switching the DC input voltage V_{IN} at step 204. In some embodiments, such as in the example dual DC-DC converter 20′ shown in FIG. 2, step 204 is performed using one or more of the switches 32, 34 within the second switch set 38. More specifically, the controller 30 may command the one or more of the switches 32, 34 within the second switch set 38 using a control scheme, such as a pulse width modulation (PWM) scheme to generate the second DC output voltage V_{OUT2} by controlling an amount of time that of one or more of the switches 32, 34 within the second switch set 38 are energized within a given time period. In some embodiments, such as in the example dual DC-DC converter 20′ shown in FIG. 2, a second battery 23 is connected between the second output node 52 and the ground 42.

The method 200 also includes isolating the first output node 50 from the second output node 52 at step 206, thus providing for the second DC output voltage V_{OUT2} to be different than the first DC output voltage V_{OUT1}. In some embodiments, such as in the example dual DC-DC converter 20′ shown in FIG. 2, step 206 is performed by opening or maintaining a mode switch 70 connected between output nodes 50, 52 in an open or non-conducting condition.

In some embodiments, the method 200 also may include regulating a current provided to each of the output nodes 50, 52 at step 208. For example, each of the output nodes 50, 52 may be energized with a DC voltage value that provides a current that does not exceed a predetermined current. In battery charging applications, the predetermined current may be a predetermined maximum charging current to charge the respective one of the batteries 22, 23 connected to each of the output nodes 50, 52. In some embodiments, the regulation of current provided to each of the output nodes 50, 52 may be performed only when the first output node 50 is isolated from the second output node 52. In some embodiments, the example dual DC-DC converter 20′ may be configured to monitor the electrical current being provided to each of the batteries 22, 23 and to charge the batteries 22, 23 with a maximum safe charging current.

The method 200 continues with matching the DC output voltages V_{OUT1}, V_{OUT2} at step 210. More specifically, step 210 includes changing at least one of the DC output voltages V_{OUT1}, V_{OUT2} on at least one of the output nodes 50, 52 until the DC output voltages V_{OUT1}, V_{OUT2} on the output nodes 50, 52 are equal or within a predetermined threshold, or voltage difference, from one another. In some embodiments, such as in the example dual DC-DC converter 20′ shown in FIG. 2, step 210 is performed by changing the switching of one or more of the switches 32, 34 within the first switch set 36 and/or the second switch set 38 by the controller 30. This step 208 may include balancing the charge levels of the two batteries 22, 23 connected to the output nodes 50, 52.

The method 200 continues with connecting the first output node 50 to the second output node 52 at step 212, thus providing for the second DC output voltage V_{OUT2} to be the same as the first DC output voltage V_{OUT1}. In some embodiments, such as in the example dual DC-DC converter 20′ shown in FIG. 2, step 212 is performed by closing or maintaining a mode switch 70 connected between output nodes 50, 52 in a closed or conducting condition. In some embodiments, the first output node 50 is connected to the second output node 52 at step 210 to provide electrical continuity therebetween in response to the DC output voltages V_{OUT1}, V_{OUT2} on the output nodes 50, 52 being equal or within the predetermined threshold from one another. In other words, step 212 may be performed only after step 210 is complete. For example, the dual DC-DC converter 20′ may be configured to close the mode switch 70 if the DC output voltages V_{OUT1}, V_{OUT2} on the output nodes 50, 52 are less than or equal to 0.5 volts of one-another. The mode switch 70 may be controlled by the controller 30 or by another processor or circuit, such as a voltage comparator. In some embodiments, one or more time delays or other prerequisites may also be required before the mode switch 70 is allowed to be closed. Such other prerequisites may include, for example, the batteries 22, 23 being determined to be in working order, or the electrical current being supplied to one or both of the batteries 22, 23 being within a predetermined value or range of values.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A dual DC-DC converter comprising:
a first switch set including a first high-side switch and configured to generate a first DC output voltage upon a first output node by selectively closing the first high-side switch to couple an input node having a DC input voltage to a first common node;
a second switch set including a second high-side switch and configured to generate a second DC output voltage upon a second output node by selectively closing the second high-side switch to couple the input node to a second common node; and
a mode switch configured to selectively couple the first output node to the second output node.

2. The dual DC-DC converter of claim 1, wherein at least one of the first switch set and the second switch set includes a low-side switch configured to selectively couple a ground to a corresponding one of the first common node or the second common node.

3. The dual DC-DC converter of claim 1, wherein each of the switch sets are operated in an interleaved mode or multiphase mode.

4. The dual DC-DC converter of claim 1, further comprising a filter capacitor connected between a ground and one of the output nodes.

5. The dual DC-DC converter of claim 1, further comprising an inductor connected between one of the common nodes and a corresponding one of the output nodes.

6. The dual DC-DC converter of claim 1, further comprising a controller configured to control the DC output voltage on each of the output nodes by controlling switching of the first high-side switch within the first switch set and by controlling switching the second high-side switch within the second switch set by selectively asserting a control line associated with each of the high-side switches.

7. The dual DC-DC converter of claim 6, wherein the controller is configured to assert a mode control line to selectively couple the first output node to the second output node.

8. A battery charger comprising:
a first switch set configured to control a first DC output voltage on a first output node and to control a rate of charge into a first battery connected thereto;
a second switch set configured to control a second DC output voltage on a second output node and to control a rate of charge into a second battery connected thereto;
a mode switch electrically connected between the output nodes and operable in a non-conductive mode to provide electrical isolation between the output nodes for allowing the first battery and the second battery to be charged independently; and
wherein the mode switch is operable in a conductive mode to provide electrical continuity between the output nodes.

9. The battery charger of claim 8, further comprising:
a controller configured to assert a mode control line to cause the mode switch to be in the conductive mode; and
wherein the controller is configured to assert the mode control line in response to a difference between the first DC output voltage and the second DC output voltage being within a predetermined threshold.

10. A method of operating a dual DC-DC converter comprising:
generating a first DC output voltage upon a first output node by switching a DC input voltage;
generating a second DC output voltage upon a second output node by switching the DC input voltage; and
coupling the first output node to the second output node with a mode control switch to cause the second output voltage to be equal to the first output voltage.

11. The method of claim 10, further comprising regulating a current provided to each of the output nodes not to exceed a predetermined current.

12. The method of claim 10, further comprising changing at least one of the DC output voltages on at least one of the output nodes until the DC output voltages are within a predetermined voltage difference from one another.

13. The method of claim 12, wherein changing at least one of the DC output voltages includes changing the switching of one or more switches within a first switch set coupled to the first output node or changing the switching of one or more switches within a second switch set coupled to the second output node.

14. The method of claim 12, wherein changing at least one of the DC output voltages includes balancing a charge level of a first battery connected to the first output node with a charge level of a second battery connected to the second output node.

15. The method of claim 12, wherein the coupling the first output node to the second output node is performed in response to the DC output voltages being within the predetermined voltage difference from one another.

16. The dual DC-DC converter of claim 1, further comprising an inductor connected between the first common node and a corresponding one of the output nodes, and another inductor connected between the second common node and a corresponding one of the output nodes.

17. The dual DC-DC converter of claim 1, wherein the DC input voltage has a voltage of 400 to 600 VDC.

18. The battery charger of claim 8, wherein the first switch set includes a first high-side switch configured to selectively couple an input node having a DC input voltage to the first common node; and
wherein the second switch set includes a second high-side switch configured to selectively couple the input node to the second common node.

19. The battery charger of claim 8, wherein each of the switch sets are operated in an interleaved mode or multiphase mode.

20. The battery charger of claim 8, wherein the DC input voltage has a voltage of 400 to 600 VDC.
